(19) United States
(12) Patent Application Publication
(10) Pub. No.: US 2017/0262189 A1
(43) Pub. Date: Sep. 14, 2017

(54) MEMORY MANAGEMENT SYSTEM AND METHODS

(71) Applicant: City of Hope, Duarte, CA (US)

(72) Inventors: Tahir Ali, Glendora, CA (US); Romeo Y. Rodriguez, La Verne, CA (US); John D. Negrete, Alhambra, CA (US)

(21) Appl. No.: 15/512,773

(22) PCT Filed: Sep. 23, 2015
(86) PCT No.: PCT/US15/51621

§ 371 Date: Mar. 20, 2017

Related U.S. Application Data
(60) Provisional application No. 62/056,067, filed on Sep. 26, 2014.

(51) Int. Cl. G06F 3/06; G06F 12/08

(52) U.S. Cl. CPC G06F 3/0608; G06F 12/08; G06F 3/0649; G06F 3/0685; G06F 2212/1044; G06F 2212/205; G06F 2212/214; G06F 2212/217; G06F 2212/70; G06F 2212/7205

(57) ABSTRACT

A memory management system and methods of using the same are disclosed herein. The memory management system can include storage devices including a tier 0 memory and a tier 1 memory. The storage devices can be connected to one or several user devices via one or several SANs and one or several virtualization devices. The one or several virtualization devices can control the storing of data in the storage devices such that a piece of data is stored in one of the tier 0 memory and the tier 1 memory based on a data attribute of the piece of data. Particularly, the piece of data can be stored in the tier 0 memory until a predetermined amount of time has passed, and the piece of data can then be moved to the tier 1 memory.

### REFERENCE TO PRIORITY DOCUMENT

This application claims priority to co-pending U.S. Provisional Patent Application Ser. No. 62/056,067 entitled MEMORY MANAGEMENT SYSTEM AND METHODS on Sep. 26, 2014. Priority to the aforementioned filing date is claimed and the provisional application is incorporated by reference in its entirety.

### BACKGROUND

Hierarchical storage management (HSM) is a data storage technique, which automatically moves data between high-cost and low-cost storage media. HSM systems exist because high-speed storage devices, such as hard disk drive arrays, are more expensive (per byte stored) than slower devices, such as optical discs and magnetic tape drives. While it would be ideal to have all data available on high-speed devices all the time, this is prohibitively expensive for many organizations.

HSM is sometimes referred to as tiered storage. These different tiers can include, for example, Tier 0 memory, Tier 1 memory, and Tier 2 memory. Many strategies are used in managing HSM to decrease costs of the memory and to increase the usability of the memory. These current strategies frequently include the creation of multiple copies of a single item in multiple tiers of memory to gain the benefits of each tier. While these strategies can be effective, further memory management systems and methods are desired.

### SUMMARY

One aspect of the present disclosure relates to a system for memory management. The system can include a storage area network including a tier 0 memory, which tier 0 memory can include flash memory and a tier 1 memory, which tier 1 memory can include non-flash memory. The system can include a user device connected to the storage area network, which user device can include coded instructions to store data in the storage area network and retrieve data from the storage area network, and a processor that can include coded instructions to direct the storage and retrieval of data from the storage area network, which coded instructions can direct the processor to store a first piece of data on one of the tier 0 memory and the tier 1 memory, and when an attribute of the first piece of data changes, the coded instructions can direct the processor to store the first piece of data on the other of the tier 0 memory and the tier 1 memory.

In some embodiments, the processor can include coded instructions to initially store the first piece of data in the tier 0 memory until the attribute of the first piece of data changes. In some embodiments, the attribute of the first piece of data can include one of: the age of the first piece of data, the type of the first piece of data, and the frequency of use of the first piece of data. In some embodiments, the attribute of the first piece of data can include a duration of time elapsed since the latest of one of: reading of the first piece of data, and writing to the first piece of data. In some embodiments, the processor can include coded instructions to start a clock when the first piece of data is either read or written to. In some embodiments, the processor can include coded instructions to compare the clock to a threshold value, and when the value of the clock is greater than the threshold value, to move the first piece of data from the tier 0 memory to the tier 1 memory.

In some embodiments, the processor can include coded instructions to store a copy of the first data piece in the tier 1 memory and to delete a copy of the first piece of data stored in the tier 0 memory when the first piece of data is moved from the tier 0 memory to the tier 1 memory. In some embodiments, the system includes tier 2 memory, and in some embodiments, a copy of the first piece of data can be stored in the tier 2 memory simultaneous with storing of a copy of the first piece of data in one of the tier 0 memory and the tier 1 memory. In some embodiments, the system can be configured such that a copy of the first piece of data is not simultaneously stored within both the tier 0 and the tier 1 memory.

In some embodiments, the tier 0 storage can include multiple internal redundancies. In some embodiments, the multiple internal redundancies of the tier 0 storage can include a redundant array of independent disks. In some embodiments, the redundant array of independent disks can include a level of at least RAID 4, a level of at least RAID 5, or a level of at least RAID 6.

One aspect of the present disclosure relates to a method of operating a storage area network, which storage area network includes a tier 0 memory having flash memory and a tier 1 memory having non-flash memory. The method can include receiving a first piece of data from a user device, identifying an attribute of the first piece of data, storing the first piece of data in one of a tier 0 memory and a tier 1 memory, and storing the first piece of data in the other of the tier 0 memory and the tier 1 memory when the attribute of the first piece of data changes.

In some embodiments of the method, the first piece of data is initially stored in the tier 0 memory. In some embodiments, the first piece of data is stored in the tier 1 memory after the attribute of the first piece of data changes. In some embodiments, the attribute of the first piece of data can include one of: the age of the first piece of data, the type of the first piece of data, and the frequency of use of the first piece of data. In some embodiments, the attribute of the first piece of data can include a duration of time elapsed since the latest of one of: reading of the first piece of data, and writing to the first piece of data.

In some embodiments, the method includes starting a clock when the first piece of data is either read or written to. In some embodiments, the method can include comparing the clock to a threshold value, and moving the first piece of data from the tier 0 memory to the tier 1 memory when the value of the clock is greater than the threshold value. In some embodiments, when the first piece of data is moved from the tier 0 memory to the tier 1 memory, a copy of the first data piece is stored in the tier 1 memory and a copy of the first piece of data stored in the tier 0 memory is deleted. In some embodiments, a copy of the first piece of data is stored in a tier 2 memory simultaneously with the storing of a copy of the first piece of data in one of the tier 0 memory and the tier 1 memory, and in some embodiments, a copy of the first piece of data is not simultaneously stored within both the tier 0 and the tier 1 memory. In some embodiments, the tier 0 storage can include multiple internal redundancies which can be, for example, a redundant array of independent disks. In some embodiments, the redundant array of independent disks comprises a level of at least RAID 4, a level of at least RAID 5, or a level of at least RAID 6.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 is a schematic illustration of one embodiment of a memory management system.

FIG. 2 is a schematic illustration of hardware of one embodiment of a memory management system.

FIG. 3 is a flowchart illustrating one embodiment of a process for managing memory within a memory management system.

FIG. 4 is a flowchart illustrating one embodiment of a process for storing an item within a memory management system.

FIG. 5 is a block diagram of an embodiment of a computer system.

FIG. 6 a block diagram of an embodiment of a special-purpose computer system.

In the appended figures, similar components and/or features may have the same reference label. Where the reference label is used in the specification, the description is applicable to any one of the similar components having the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

### Definitions

As used herein, a “user device” is a computing device that is being controlled by a user. The user device can be a personal computer (PC), a laptop computer, a server, a smartphone, a tablet, or the like. In some embodiments, the user device can run any desired operating system.

As used herein, a “memory management system” is a system of communicatingly connected computer hardware that can be used to store one or several pieces of data and/or to allow retrieval of one or several pieces of data. The memory management system can include one or several storage devices including, for example, solid-state drives, hard drives, magnetic drives, disk drives, magnetic tape data storage devices, or the like, one or several storage area networks (SAN), one or several storage virtualization devices, one or several user devices, one or several networking and/or communication devices, and/or the like.

As used herein, a “storage area network” (SAN) refers to a dedicated network that provides access to data storage, and particularly that provides access to consolidated, block level data storage. A SAN typically has its own network of storage devices that are generally not accessible through the local area network (LAN) by other devices. The SAN allows access to these devices in a manner such that these devices appear to be locally attached to the user device.

As used herein, a “storage virtualization device” refers to a device that groups physical storage from multiple storage devices and provides a gateway to these grouped storage devices. The storage virtualization device masks the complexity of the SAN to the user and creates the appearance, to the user, of interacting with a single storage device. The storage virtualization device can be implemented using software and/or hardware and can be applied to any level of the SAN. In some embodiments, the storage virtualization device can be implemented on one or several processors, computers, servers, or the like.

As used herein “Tier 0 storage,” also referred to herein as “tier 0 storage” or “tier 0 memory,” refers to storage that forms a part of the memory management system. Tier 0 storage also is the fastest tier of storage in the memory management system, and, particularly, the tier 0 storage is the fastest storage that is not RAM or cache memory. In some embodiments, the tier 0 memory can be embodied in solid state memory such as, for example, a solid-state drive (SSD) and/or flash memory. In some embodiments, the tier 0 storage can be made of one or several drives that can be, for example, configured such that the tier 0 storage is RAID 5 storage. In one particular embodiment, one or several of the drives of the tier 0 storage can be hot swappable.

As used herein, “Tier 1 storage,” also referred to herein as “tier 1 storage” or “tier 1 memory,” refers to storage that forms a part of the memory management system. Tier 1 storage is one or several higher performing systems in the memory management system, and is relatively slower than tier 0 memory, and relatively faster than other tiers of memory. The tier 1 memory can be one or several hard disks that can be, for example, high-performance hard disks, that can be one or both of physically or communicatingly connected such as, for example, by one or several fiber channels. In some embodiments, the one or several disks can be arranged into a disk storage system, and specifically can be arranged into an enterprise class disk storage system. The disk storage system can include any desired level of redundancy to protect data stored therein, and in one embodiment, the disk storage system can be made with grid architecture that creates parallelism for uniform allocation of system resources and balanced data distribution.

As used herein, “Tier 2 storage,” also referred to herein as “tier 2 storage” or “tier 2 memory,” refers to storage that forms a part of the memory management system. Tier 2 storage includes one or several relatively lower performing systems in the memory management system, as compared to the tier 1 and tier 2 storages. Thus, tier 2 memory is relatively slower than tier 1 and tier 0 memories. Tier 2 memory can include one or several SATA-drives or one or several NL-SATA drives.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

As used herein “solid-state storage,” also referred to herein as “solid-state memory” or “solid-state drive,” are data storage devices that store data electronically. A solid-state drive has no moving mechanical parts but uses one or several integrated circuit assemblies as memory to persistently store data. Solid-state drives are either RAM based, or flash based. Solid-state memory provides faster and more consistent input and output times than other forms of memory.

As used herein, “flash memory” refers to an electronic non-volatile computer storage medium that can be electrically erased and reprogrammed. Flash memory is EEPROM (electrically erasable programmable read-only memory), and is one of two types, either NAND type or NOR type.

As used herein, “a piece of data,” also referred to herein as a “data piece,” can be a subset or group of data. The piece of data can be generated, modified, and/or used, including read, by a user. In one exemplary embodiment, a piece of data can comprise all of the data associated with a document such as a report, a result, a study, or the like. In some embodiments, the piece of data can have one or several data attributes.

As used “data attribute” refers to one or several qualities or characteristics of a piece of data or relating to a piece of data. The data attribute can relate to an aspect of the piece of data such as, for example, the size, type, or content of the piece of data. Similarly, the data attribute can identify a quality relating to the piece of data such as the age of the piece of data, the time of the most recent read of and/or write to the piece of data, the amount of time passed since a read of and/or write to the piece of data including, for example, the most recent read of and/or write to the piece of data, the frequency of use, of accessing, of reading of and/or writing to the piece of data, or the like.

As used herein, “threshold value” refers to a value indicative of a magnitude or intensity that, when reached and/or exceeded, results in the occurrence of a certain reaction or event. In some embodiments, the threshold value can relate to a data attribute and can be used in conjunction with the related data attribute to determine a categorization of the piece of data, and particularly to determine in which tier of the memory management system a piece of data should be stored.

As used herein, “RAID” (redundant array of inexpensive disks or redundant array of independent disks) identifies the degree to which a memory device combines multiple memory components for purposes of data redundancy and/or performance improvement, in other words, the degree to which one or several internal redundancies are included in a device. The degree of redundancy is described by a “RAID level.” As used herein, “RAID 0” is a RAID level that has no data redundancy and no error detection mechanism. As used herein, “RAID 1” is a RAID level in which data is written identically to two (or more) drives to produce a mirrored set. As used herein, “RAID 3” is a RAID level that includes byte level striping and dedicated parity on a dedicated parity drive. As used herein, “RAID 4” is a RAID level that includes block-level striping with dedicated parity. As used herein, “RAID 5” is a RAID level that includes block-level striping with distributed parity in which parity information is distributed among the drives. A RAID 5 device can operate if one of the drives fails. As used herein, “RAID 6” is a raid level that includes block-level striping with double distributed parity. This double parity allows the RAID 6 device to operate if two drives fail.

### Memory Management System

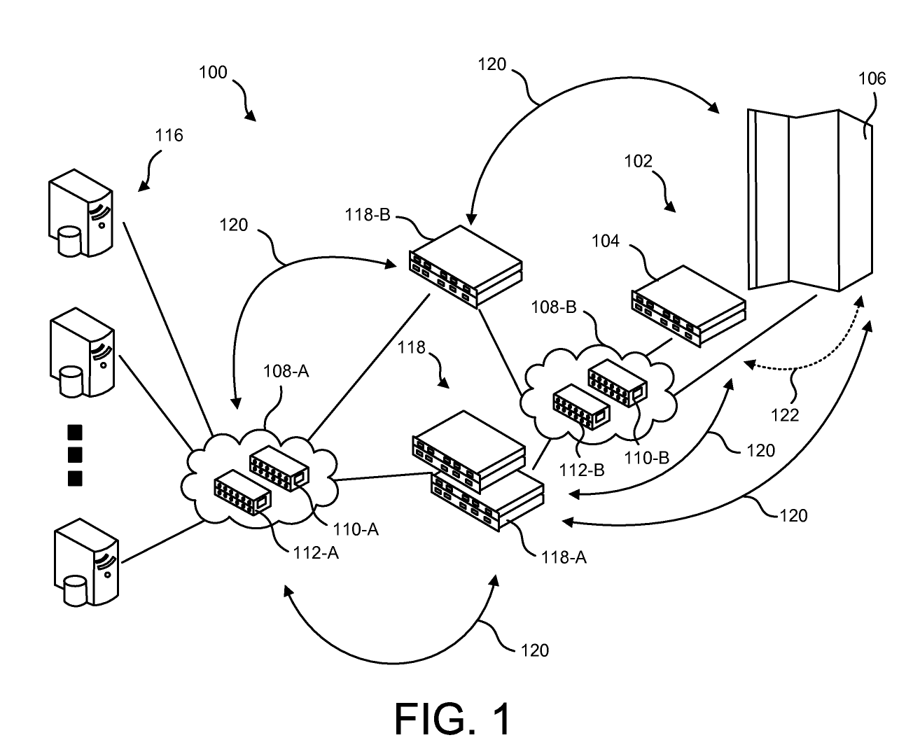

With reference now to FIG. 1, a schematic illustration of one embodiment of a memory system 100 is shown. The memory management system can include one or several components and/or devices that can together store and/or retrieve one or several pieces of data.

In some embodiments, the one or several components of the memory management system 100 can include one or several storage devices 102, which can be the devices of the memory management system 100 in which one or several pieces of data are stored. These storage devices can include a tier 0 memory 104 and a tier 1 memory 106. In one particular embodiment, the tier 0 memory 104 can be a flash drive, and the tier 1 memory 106 can be a disk storage system.

In some embodiments in which the tier 0 memory 104 comprises one or several solid-state drives, and particularly comprises one or several flash drives, the tier 0 memory 104 can be configured such that failure of one of the drives does not result in the loss of memory. In one particular embodiment, this can be achieved if the tier 0 memory 104 is a RAID 3 device, a RAID 4 device, a RAID 5 device, a RAID 6 device, or a device at a higher RAID level. In one particular embodiment, the reliability of the tier 0 memory 104 can be further improved by making one or several of the drives hot swappable in that these one or several drives can be removed and replaced without shutting-down the tier 0 memory 104. In one particular embodiment, the tier 0 memory 104 can include 1, 2, 3, 4, 5, 6, 7, 8, 9, 10, 20, 50, 100 and/or any other or intermediate number of hot swappable drives.

In some embodiments, the one or several storage devices 102 can further include a tier 2 memory, a tier 3 memory, or any other desired tier of memory. In one particular embodiment, a copy of the piece of data can be stored in the tier 2, or any other higher tier, memory simultaneous with the storing of the piece of data in one or both of the tier 0 memory 104 and the tier 1 memory 106. Advantageously, this provides a backup in the event that one or both of the tier 0 memory 104 and the tier 1 memory 106 fail.

The memory management system 100 can include SANs 108, and can particularly include server side SAN 108-A and storage side SAN 108-B. The server side SAN 108-A and the storage side SAN 108-B can be split evenly into two fabrics to achieve balanced performance and high availability. In the embodiment of FIG. 1, the server side SAN 108-A is divided into a server side “A” fabric 110-A and a server side “B” fabric 112-A, and the storage side SAN 108-B is divided into a storage side “A” fabric 110-B and a storage side “B” fabric 112-B.

The SANs 108 can serve to provide a virtual interface between components of the memory management system 100, and specifically, the server side SAN 108-A can interface between user devices 116 and storage virtualization devices 118.

The storage virtualization devices 118 can be any type of storage virtualization devices including, for example, block storage virtualization devices. The storage virtualization devices 118 can be arranged into a cluster, and, as depicted in FIG. 1, can be arranged into a production cluster 118-A and a non-production cluster 118-B. In some embodiments, the production cluster 118-A can include all of the production data, and in some embodiments, the non-production cluster does not contain all of the production data. In some further embodiments, the non-production cluster 118-B may utilize Flash storage, and in some embodiments, the non-production cluster 118-B may utilize Flash storage. The storage virtualization devices 118 can each include one or several nodes, and, in some embodiments, can include 1, 2, 3, 4, 5, 6, 7, 8, 9, 10, or any other number of nodes. In one particular embodiment, the production cluster 118-A can include four nodes, and the non-production cluster 118-B can include two nodes. As indicated with arrows 120, the storage virtualization devices 118 can direct and/or manage the delivery of one or several pieces of data between the user devices 116 and the storage devices 102. In some embodiments, and as indicated by arrow 122, the storage virtualization devices 118 can manage delivery of one or several pieces of data between the tier 0 memory 104 and the tier 1 memory 106.

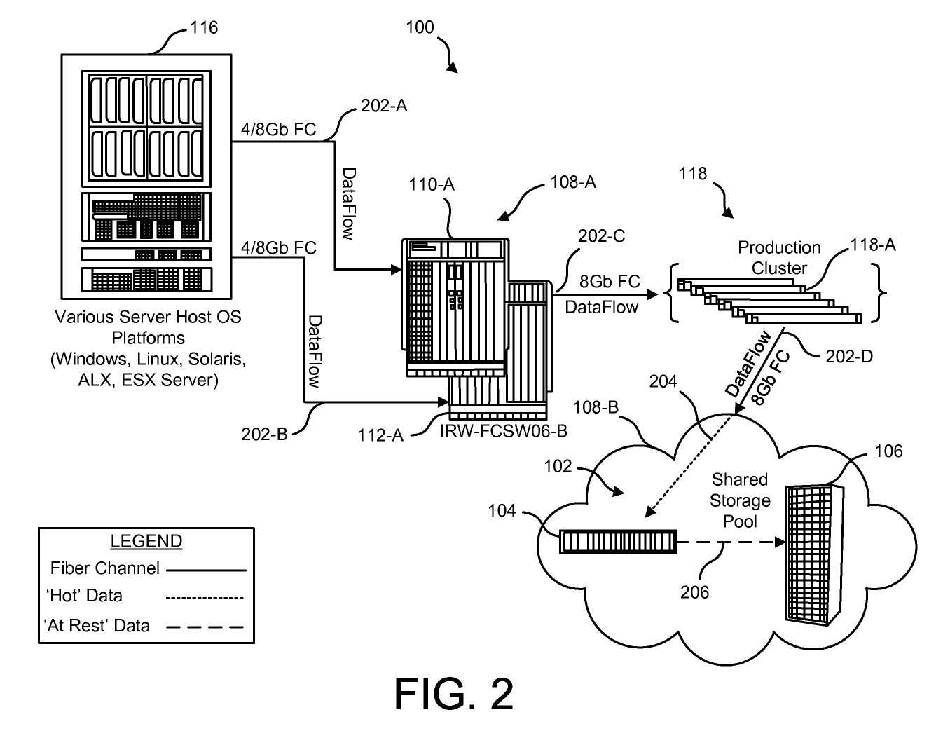

With reference now to FIG. 2, a schematic illustration of hardware and dataflow of one embodiment of a memory management system 100 is shown. Like the embodiment of FIG. 1, the memory management system 100 includes the storage devices 102 including the tier 0 memory 104 and the tier 1 memory 106, the virtualization devices 118, and particularly the production cluster 118-A, the server side SAN 108-A that is divided into the server side “A” fabric 110-A and the server side “B” fabric 112-A, the storage side SAN 108-B, and the user device 116.

In some embodiments, the components of the memory management system 100 can be communicatingly connected. In the embodiment depicted in FIG. 2, the components of the memory management system 100 are communicatingly connected via fiber channel, and specifically, the user device 116 and the server side SAN 108-A are connected by a first fiber channel 202-A connecting the user device 116 to the server side “A” fabric 110-A and a second fiber channel 202-B connecting the user device 116 to the server side “B” fabric 112-A. In some embodiments, the first and second fiber channels 202-A, 202-B can be capable of transmitting signals at any desired speed, and in some embodiments, the first and second fiber channels 202-A, 202-B can transmit signals at 1 Gb/s, 2 Gb/s, 4 Gb/s, 8 Gb/S, 10 Gb/s, and/or any other or intermediate speed. In some embodiments, the server side SAN 108-A is connected to the virtualization device 118 via a third fiber channel 202-C, and the virtualization device 118 is connected to the storage side SAN 108-B via a fourth fiber channel 202-D. The second and third fiber channels 202-C, 202-D can transmit signals at 1 Gb/s, 2 Gb/s, 4 Gb/s, 8 Gb/S, 10 Gb/s, 12 Gb/s, 14 Gb/s, and/or any other or intermediate speed.

In some embodiments, once the piece of data is received at the storage side SAN 108-B, the data can be initially received and/or stored in the tier 0 memory as indicated by arrow 204 and a data attribute of the piece of data can be determined. In some embodiments, this data attribute of the received piece of data can be monitored until the data attribute changes and/or triggers a threshold value, at which point the piece of data can be received and/or stored in the tier 1 memory 106, and the copy of the piece of data in the tier 0 memory 104 can be deleted. Similarly, if data is being retrieved from the storage devices 102, the direction of data flow indicated by arrows 204, 206 and fiber channels 202 reverses. In such an embodiment, if data is retrieved that is stored on the tier 0 memory, then the data is directly accessed in the tier 0 memory 104 and an attribute of the piece of data is monitored. If such retrieved data is stored in the tier 1 memory 106, the piece of data is first copied from the tier 1 memory 106 to the tier 0 memory 104, the copy of the data in the tier 1 memory 106 is deleted, the piece of data is accessed via the tier 0 memory 104, and an attribute of the piece data is monitored. The processes by which data is retrieved and/or stored in the storage device 102 are discussed at greater length below.

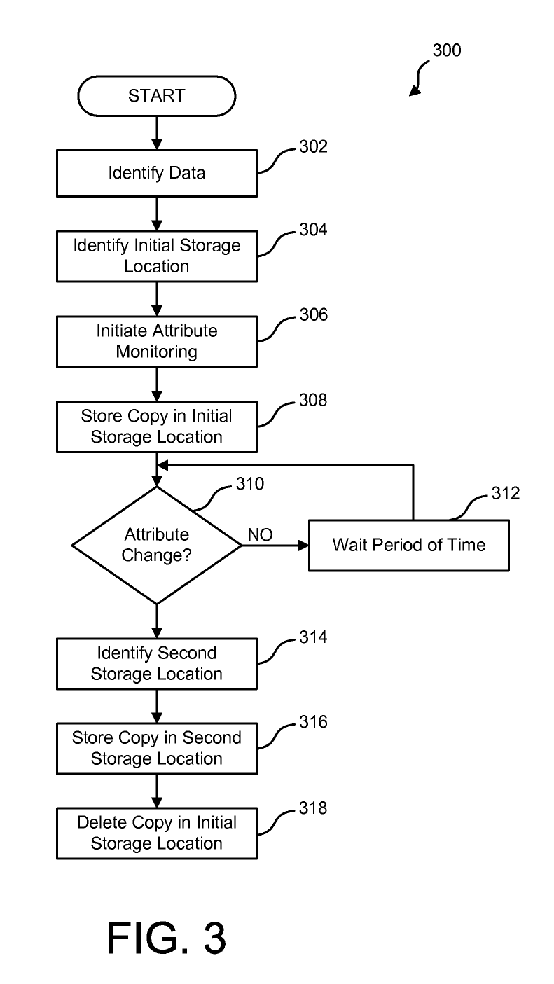

With reference now to FIG. 3, a flowchart illustrating one embodiment of a process 300 for managing memory within a memory management system 100 is shown. The process 300 identifies how the storage location of at least one piece of data is determined and the conditions under which the storage location of at least one piece of data are changed. The process 300 can be performed by the memory management system 100 and/or components thereof, and in some embodiments, can be performed by the virtualization device 118.

The process 300 begins at block 302 wherein the piece of data is identified. In some embodiments, the piece of data can be received by the virtualization device 118 from the user device 116 via the server side SAN 108-A, and can be identified at the time of receipt. After the piece of data has been identified, the process 300 proceeds to block 304, wherein an initial storage location is determined.

In some embodiments, this can include retrieving one or several storage rules located in the virtualization device 118 and/or that are accessible to the virtualization device 118. These storage rules can, for example, identify one or several data attributes and one or several storage devices in which pieces of data having those identified data attributes can be stored. After these rules are retrieved, the virtualization device 118 can determine the data attributes of the received and identified piece of data and determine the storage location for the piece of data.

In the embodiment depicted in FIG. 2, the storage rules can indicate that a newly received and/or newly written-to piece of data is stored in tier 0 memory 104 and that the piece of data remains there until a predetermined amount of time passes since its most recent read and/or write.

After the initial storage location of the piece of data is determined, the process 300 proceeds to block 306 wherein attribute monitoring is initiated. In some embodiments, this attribute monitoring can be used to monitor the state of the attribute to determine if and/or when the piece of data should be moved from an initial storage location to a second storage location, and/or similarly to determine if the piece of data should be moved from a second storage location to a third storage location. In some embodiments, the attribute monitoring can include the starting of a clock that can measure the amount of time passed since the most recent of a read and/or write to the piece of data.

After the attribute monitoring has been initiated, the process 300 proceeds to block 308, wherein a copy of the piece of data and/or the piece of data is stored in the initial storage location. After the piece of data and/or a copy thereof has been stored in the initial storage location, the process 300 proceeds to decision state 310, wherein it is determined if the data attribute has changed. In some embodiments, this determination can include determining whether the data attribute has changed such that the attribute triggers a threshold value and/or such that if the data attribute previously did not reach and/or surpass the threshold value, it now reaches and/or surpasses the threshold value, and such that if the data attribute previously reached and/or surpassed the threshold value, it now does not reach and/or surpass the threshold value.

If it is determined that the threshold value is not triggered, then the process 300 proceeds to block 312 and waits for a period of time, which period can be predetermined or un-predetermined. After the process 300 waits for the passing of the period of time, the process 300 returns to decision state 310.

Returning again to decision state 310, if it is determined that the threshold value is triggered, the process 300 proceeds to block 314, wherein the second storage location is identified. In some embodiments, the second storage location can be identified based on the one or several storage rules. In the embodiment depicted in FIG. 2, the second storage location can be the tier 1 memory.

After the second storage location has been identified, the process 300 proceeds to block 316, wherein a copy of the piece of data is stored in the second storage location. In some embodiments, this can include the re-commencing of attribute monitoring as mentioned in block 306 if additional moves in storage location are possible. After the copy of the piece of data is stored in the second storage location, the process 300 proceeds to block 318, wherein the copy of the piece of data in the initial storage location is deleted.

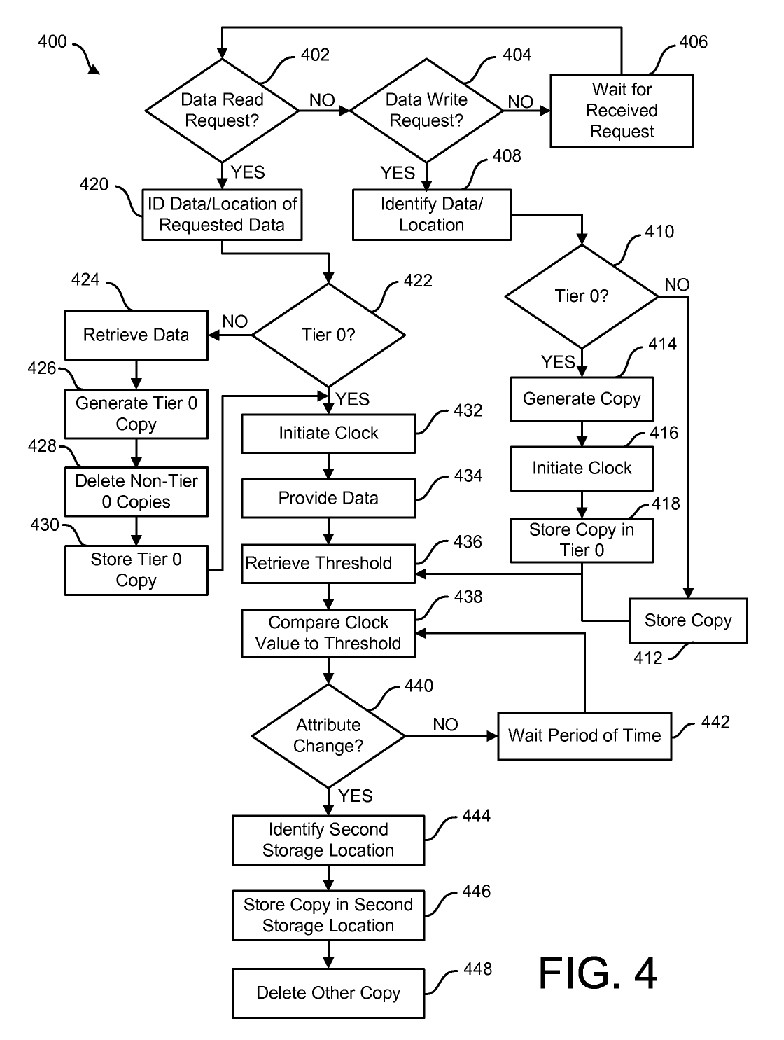

With reference now to FIG. 4, a flowchart illustrating one embodiment of a process 400 for storing an item within the memory management system 100 is shown. The process 400 specifically relates to how the storage location of at least one piece of information is determined when that at least one piece of information is already stored in the memory management system 100. The process 400 can be performed by the memory management system 100 and/or components thereof, and, in some embodiments, can be performed by the virtualization device 118.

The process 400 begins at decision state 402, wherein it is determined if a read request is received. In some embodiments, a read request can originate from one of the user devices 116 and can comprise, for example, a request to view and/or access the piece of data. If a read request is not received, then the process 400 proceeds to decision state 404 wherein it is determined if a write request is received, which write request can originate from one or several of the user devices 116. In some embodiments, the write request can comprise the saving of an updated piece of data or therewith associated document, a change to the piece of data or therewith associated document, or the like.

If it is determined that a write request is not received, then the process 400 proceeds to block 406, wherein the process 400 waits until a request is received. In some embodiments, this can include waiting a period of time, which can be, for example, predetermined or un-predetermined, and determining if a request has been received, and in some embodiments, this can include waiting until it is determined that a request has been received. After the request has been received, the process 400 returns to decision state 402 and proceeds as outlined above.

Returning again to decision state 404, if it is determined that a write request is received, the process 400 proceeds to block 408, wherein the piece of data affected by the write request and the location of that piece of data is determined. In some embodiments, this can include identifying the piece of data that is requested by the write request and determining in which of the storage device 102, and/or where in the storage devices 102, the piece of data is stored. In some embodiments, this can further include determining the location to which the piece of data will be stored after the write. This can, in some embodiments, include determining if the piece of data is stored in the tier 0 memory, and/or if the piece of data will be stored to the tier 0 memory after the write, or if the piece of data is stored in the tier 1 memory and/or if the piece of data will be stored to the tier 1 memory after the write.

After the piece of data and the location of the piece of data has been identified, the process 400 proceeds to decision state 410, wherein it is determined if the piece of data will be stored to the tier 0 memory after the write. If it is determined that the piece of data will not be stored to the tier 0 memory after the write, the process 400 proceeds to block 412, wherein the write occurs, and wherein the piece of data, and/or a copy thereof, is stored in the identified location, and in some embodiments, is stored in the tier 1 memory. After the copy has been stored, the process 400 proceeds to block 436, and proceeds as outlined below.

Returning again to decision state 410, if it is determined that the piece of data will be stored in the tier 0 memory after the write, the process 400 proceeds to block 414, wherein the write occurs, and wherein a copy of the piece of data is generated. After the copy of the piece of data is generated, the process 400 proceeds to block 416, wherein the clock is initiated, triggered, and/or noted. In some embodiments, the clock can be initiated, triggered, and/or noted to track the data attribute of the piece of data.

After the clock has been initiated and/or concurrent therewith, the process 400 proceeds to block 418, wherein a copy of the piece of data is stored in the tier 0 memory. After the copy of the piece of data has been stored in the tier 0 memory, the process 400 proceeds to block 436 and proceeds as outlined below.

Returning again to decision state 402, if it is determined that a data read request is received, the process 400 proceeds to block 420, wherein the piece of data affected by the read request is identified and the location of that piece of data is determined. In some embodiments, this can include identifying the piece of data that is requested by the read request and determining in which of the storage devices 102, and/or where in the storage devices 102, the piece of data is stored.

After the piece of data and its location have been identified, the process 400 proceeds to decision state 422, wherein it is determined if the piece of data is stored in the tier 0 memory 104. If the piece of data is not stored in the tier 0 memory, then the process 400 proceeds to block 424, wherein the piece of data is retrieved. In some embodiments, the piece of data can be retrieved from another tier of the memory such as, for example, the tier 1 memory.

After the piece of data has been retrieved, the process 400 proceeds to block 426, wherein a tier 0 copy of the piece of data is generated. In some embodiments, the tier 0 copy of the piece of data can be a copy that is later stored in the tier 0 memory 104. After the tier 0 copy has been generated, the process 400 proceeds to block 428, wherein non-tier 0 copies of the piece of data are deleted. In some embodiments, this deletion can prevent the storage devices 102 from being cluttered by one or several redundant copies of the piece of data.

After the non-tier 0 copies of the piece of data have been deleted, the process 400 proceeds to block 430, wherein the tier 0 copy is stored, in some embodiments, in the tier 0 memory 104. After the tier 0 copy is stored, or if, returning again to decision state 422, it is determined that the data was already stored in the tier 0 memory 104, the process proceeds to block 432, wherein the clock is initiated, triggered, and/or noted. In some embodiments, the clock can be initiated, triggered, and/or noted to track the data attribute of the piece of data.

After the clock has been initiated, triggered, and/or noted, the process 400 proceeds to block 434, wherein the piece of data is provided. In some embodiments, the piece of data can be provided from the storage devices 102 to the storage side SAN 108-B, to the virtualization devices 118, to the server side SAN 108-A, and ultimately to the requesting one or several of the user devices 116. After the piece of data has been provided, the process 400 proceeds to block 436, wherein the threshold value is retrieved. In some embodiments, the threshold value can be used to determine when the data attribute is such that the piece of data should be moved from the tier 0 memory 104 to the tier 1 memory 106, or alternatively, when the piece of data should be moved from one storage location to another storage location.

After the threshold has been retrieved, the process 400 proceeds to block 438, wherein the data attribute, and, in this case, the clock value, is compared with the threshold value. In some embodiments, this comparison can be performed according to a Boolean-function, and a first, “true” value can be associated with the piece of data if the threshold value has been triggered, and a second, “false” value can be associated with the piece of data if the threshold value has not been triggered.

After the data attribute has been compared to the threshold value, the process 400 proceeds to decision state 440, wherein it is determined if the data attribute has changed. In some embodiments, this determination can include determining whether the data attribute has changed such that the attribute triggers a threshold value and/or such that if the data attribute previously did not reach and/or surpass the threshold value, it now reaches and/or surpasses the threshold value, and such that if the data attribute previously reached and/or surpassed the threshold value, it now does not reach and/or surpass the threshold value. In light of the comparison performed in block 438, this determination can be made by, for example, receiving the Boolean-value associated with the piece of data. If the second Boolean-value is associated with the piece of data, then it is determined that the threshold value has not been triggered, and the process 400 proceeds to block 442 and waits for a period of time, which period can be predetermined or un-predetermined. After the process 400 waits for the passing of the period of time, the process 400 returns to block 438 and proceeds as outlined above.

Returning again to decision state 440, if the retrieved Boolean-value is the first value, or if it is otherwise determined that the threshold value has been triggered, the process 400 proceeds to block 444, wherein a second storage location is identified. In some embodiments, the second storage location can be identified based on the one or several storage rules. In the embodiment depicted in FIG. 2, the second storage location can be the tier 1 memory.

After the second storage location has been identified, the process 400 proceeds to block 446, wherein a copy of the piece of data is stored in the second storage location. In some embodiments, this can include the re-commencing of attribute monitoring as mentioned in block 432 if additional moves in storage devices 102 are possible. After the copy of the piece of data is stored in the second storage location, the process 400 proceeds to block 448, wherein the copy of the piece of data in the previous storage location is deleted.

As seen in process 300 and 400, in some embodiments, the piece or data, or copy thereof, is stored in one of the tier 0 memory 104 and the tier 1 memory 106, and not stored simultaneously in both of the tier 0 memory 104 and the tier 1 memory 106.

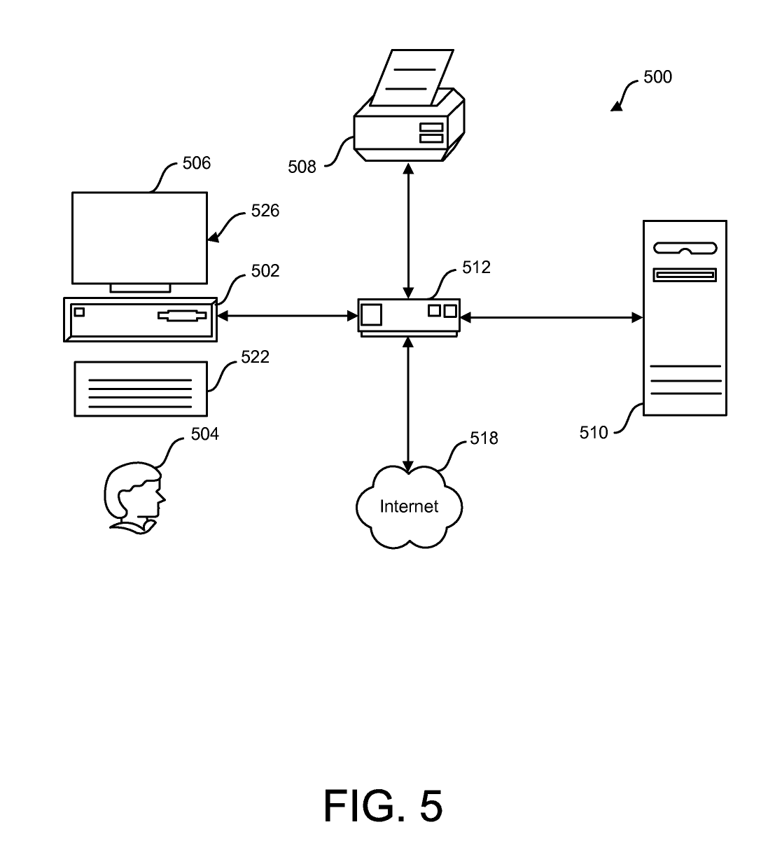

With reference now to FIG. 5, an exemplary environment with which embodiments may be implemented is shown with a computer system 500 that can be used by a user 504 as all or a component of a memory management system 100. The computer system 500 can include a computer 502, keyboard 522, a network router 512, a printer 508, and a monitor 506. The monitor 506, processor 502 and keyboard 522 are part of a computer system 526, which can be a laptop computer, desktop computer, handheld computer, mainframe computer, etc. The monitor 506 can be a CRT, flat screen, etc.

A user 504 can input commands into the computer 502 using various input devices, such as a mouse, keyboard 522, track ball, touch screen, etc. If the computer system 500 comprises a mainframe, a designer 504 can access the computer 502 using, for example, a terminal or terminal interface. Additionally, the computer system 526 may be connected to a printer 508 and a server 510 using a network router 512, which may connect to the Internet 518 or a WAN.

The server 510 may, for example, be used to store additional software programs and data. In one embodiment, software implementing the systems and methods described herein can be stored on a storage medium in the server 510. Thus, the software can be run from the storage medium in the server 510. In another embodiment, software implementing the systems and methods described herein can be stored on a storage medium in the computer 502. Thus, the software can be run from the storage medium in the computer system 526. Therefore, in this embodiment, the software can be used whether or not computer 502 is connected to network router 512. Printer 508 may be connected directly to computer 502, in which case, the computer system 526 can print whether or not it is connected to network router 512.

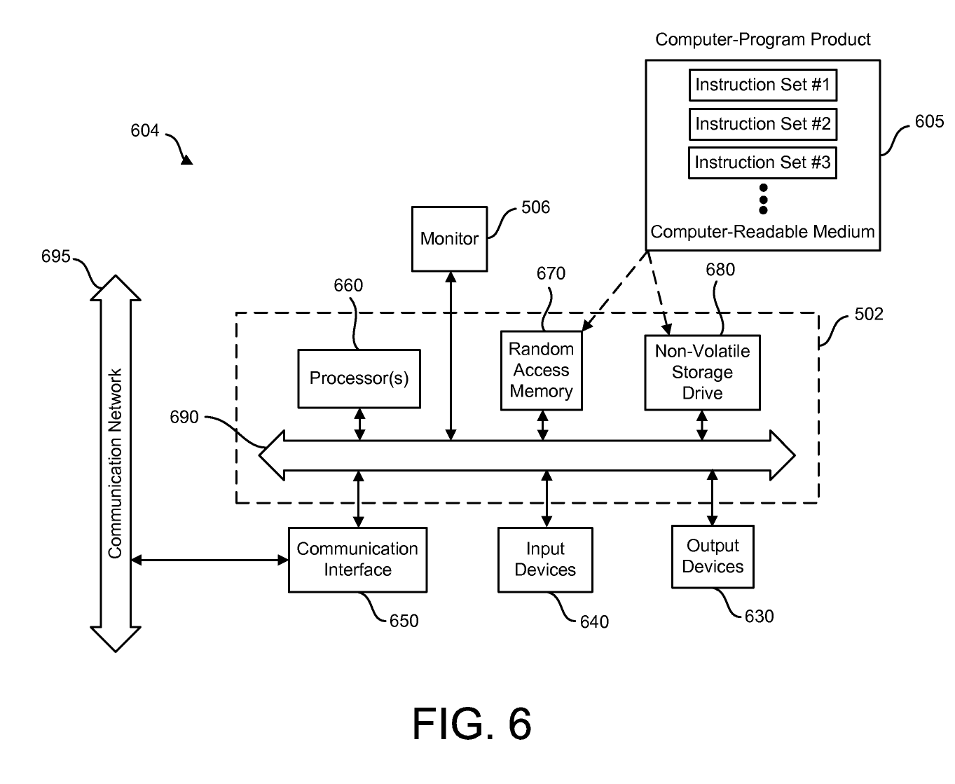

With reference to FIG. 6, an embodiment of a special-purpose computer system 604 is shown. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 526, it is transformed into the special-purpose computer system 604.

Special-purpose computer system 604 comprises a computer 502, a monitor 506 coupled to computer 502, one or more additional user output devices 630 (optional) coupled to computer 502, one or more user input devices 640 (e.g., keyboard, mouse, track ball, touch screen) coupled to computer 502, an optional communications interface 650 coupled to computer 502, a computer-program product 605 stored in a tangible computer-readable memory in computer 502. Computer-program product 605 directs system 604 to perform the above-described methods. Computer 502 may include one or more processors 660 that communicate with a number of peripheral devices via a bus subsystem 690. These peripheral devices may include user output device(s) 630, user input device(s) 640, communications interface 650, and a storage subsystem, such as random access memory (RAM) 670 and non-volatile storage drive 680 (e.g., disk drive, optical drive, solid state drive), which are forms of tangible computer-readable memory.

Computer-program product 605 may be stored in non-volatile storage drive 680 or another computer-readable medium accessible to computer 502 and loaded into memory 670. Each processor 660 may comprise a microprocessor, such as a microprocessor from Intel® or Advanced Micro Devices, Inc.®, or the like. To support computer-program product 605, the computer 502 runs an operating system that handles the communications of product 605 with the above-noted components, as well as the communications between the above-noted components in support of the computer-program product 605. Exemplary operating systems include Windows® or the like from Microsoft® Corporation, Solaris® from Oracle®, LINUX, UNIX, and the like.

User input devices 640 include all possible types of devices and mechanisms to input information to computer system 502. These may include a keyboard, a keypad, a mouse, a scanner, a digital drawing pad, a touch screen incorporated into the display, audio input devices such as voice recognition systems, microphones, and other types of input devices. In various embodiments, user input devices 640 are typically embodied as a computer mouse, a trackball, a track pad, a joystick, wireless remote, a drawing tablet, a voice command system. User input devices 640 typically allow a user to select objects, icons, text and the like that appear on the monitor 506 via a command such as a click of a button or the like. User output devices 630 include all possible types of devices and mechanisms to output information from computer 502. These may include a display (e.g., monitor 506), printers, non-visual displays such as audio output devices, etc.

Communications interface 650 provides an interface to other communication networks 695 and devices and may serve as an interface to receive data from and transmit data to other systems, WANs and/or the Internet 518. Embodiments of communications interface 650 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 650 may be coupled to a computer network, to a FireWire® bus, or the like. In other embodiments, communications interface 650 may be physically integrated on the motherboard of computer 502, and/or may be a software program, or the like.

RAM 670 and non-volatile storage drive 680 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 670 and non-volatile storage drive 680 may be configured to store the basic programming and data constructs that provide the functionality of various embodiments of the present invention, as described above.

Software instruction sets that provide the functionality of the present invention may be stored in RAM 670 and non-volatile storage drive 680. These instruction sets or code may be executed by the processor(s) 660. RAM 670 and non-volatile storage drive 680 may also provide a repository to store data and data structures used in accordance with the present invention. RAM 670 and non-volatile storage drive 680 may include a number of memories including a main random access memory (RAM) to store of instructions and data during program execution and a read-only memory (ROM) in which fixed instructions are stored. RAM 670 and non-volatile storage drive 680 may include a file storage subsystem providing persistent (non-volatile) storage of program and/or data files. RAM 670 and non-volatile storage drive 680 may also include removable storage systems, such as removable flash memory.

Bus subsystem 690 provides a mechanism to allow the various components and subsystems of computer 502 to communicate with each other as intended. Although bus subsystem 690 is shown schematically as a single bus, alternative embodiments of the bus subsystem may utilize multiple busses or communication paths within the computer 502.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A system for memory management, the system comprising:
a storage area network comprising:
a tier 0 memory, wherein the tier 0 memory comprises flash memory; and
a tier 1 memory, wherein the tier 1 memory comprises non-flash memory;
a user device connected to the storage area network, wherein the user device is configured to store data in the storage area network and retrieve data from the storage area network; and
a processor configured to direct the storage and retrieval of data from the storage area network, wherein the processor is configured to store a first piece of data on one of the tier 0 memory and the tier 1 memory, and wherein when an attribute of the first piece of data changes, the processor is configured to store the first piece of data on the other of the tier 0 memory and the tier 1 memory.

2. The system of claim 1, wherein the processor is configured to initially store the first piece of data in the tier 0 memory until the attribute of the first piece of data changes.

3. The system of claim 2, wherein the attribute of the first piece of data comprises one of:
the age of the first piece of data;
the type of the first piece of data; and
the frequency of use of the first piece of data.

4. The system of claim 2 wherein the attribute of the first piece of data comprises a duration of time elapsed since the latest of one of:
reading of the first piece of data; and
writing to the first piece of data.

5. The system of claim 4, wherein the processor is configured to start a clock when the first piece of data is either read or written to.

6. The system of claim 5, wherein the processor is configured to:
compare the clock to a threshold value; and
when the value of the clock is greater than the threshold value, to move the first piece of data from the tier 0 memory to the tier 1 memory.

7. The system of claim 6, wherein when the first piece of data is moved from the tier 0 memory to the tier 1 memory, a copy of the first data piece is stored in the tier 1 memory and a copy of the first piece of data stored in the tier 0 memory is deleted.

8. The system of 1, further comprising tier 2 memory, wherein a copy of the first piece of data is stored in the tier 2 memory simultaneous with storing of a copy of the first piece of data in one of the tier 0 memory and the tier 1 memory.

9. The system of claim 1, wherein a copy of the first piece of data is not simultaneously stored within both the tier 0 and the tier 1 memory.

10. The system of claim 1, wherein the tier 0 storage comprises multiple internal redundancies.

11. The system of claim 10, wherein the multiple internal redundancies of the tier 0 storage comprise a redundant array of independent disks.

12. The system of claim 11, wherein the redundant array of independent disks comprises a level of at least RAID 4.

13. The system of claim 11, wherein the redundant array of independent disks comprises a level of at least RAID 5.

14. The system of claim 11, wherein the redundant array of independent disks comprises a level of at least RAID 6.

15. A method of operating a storage area network, wherein the storage area network comprises a tier 0 memory comprising flash memory and a tier 1 memory comprising non-flash memory, the method comprising:
receiving a first piece of data from a user device;
identifying an attribute of the first piece of data;
storing the first piece of data in one of a tier 0 memory and a tier 1 memory; and
storing the first piece of data in the other of the tier 0 memory and the tier 1 memory when the attribute of the first piece of data changes.

16. The method of claim 15, wherein the first piece of data is initially stored in the tier 0 memory.

17. The method of claim 16, wherein the first piece of data is stored in the tier 1 memory after the attribute of the first piece of data changes.

18. The method of claim 17, wherein the attribute of the first piece of data comprises one of:
the age of the first piece of data;
the type of the first piece of data; and
the frequency of use of the first piece of data.

19. The method of claim 17 wherein the attribute of the first piece of data comprises a duration of time elapsed since the latest of one of:
reading of the first piece of data; and
writing to the first piece of data.

20. The method of claim 19, further comprising starting a clock when the first piece of data is either read or written to.

21. The method of claim 20, further comprising:
comparing the clock to a threshold value; and
moving the first piece of data from the tier 0 memory to the tier 1 memory when the value of the clock is greater than the threshold value.

22. The method of claim 21, wherein when the first piece of data is moved from the tier 0 memory to the tier 1 memory, a copy of the first data piece is stored in the tier 1 memory and a copy of the first piece of data stored in the tier 0 memory is deleted.

23. The method of 15, wherein a copy of the first piece of data is stored in a tier 2 memory simultaneously with the storing of a copy of the first piece of data in one of the tier 0 memory and the tier 1 memory.

24. The method of claim 15, wherein a copy of the first piece of data is not simultaneously stored within both the tier 0 and the tier 1 memory.

25. The method of claim 15, wherein the tier 0 storage comprises multiple internal redundancies.

26. The method of claim 25, wherein the multiple internal redundancies of the tier 0 storage comprise a redundant array of independent disks.

27. The method of claim 26, wherein the redundant array of independent disks comprises a level of at least RAID 4.

28. The system of claim 26, wherein the redundant array of independent disks comprises a level of at least RAID 5.

29. The method of claim 26, wherein the redundant array of independent disks comprises a level of at least RAID 6.
